(19) United States
(12) Patent Application Publication
(10) Pub. No.: US 2022/0098472 A1
(43) Pub. Date: Mar. 31, 2022

(54) Composition and Method for Breaking Synthetic-Polymer-Type Stimulation Fluids

(71) Applicants: CNPC USA CORPORATION, HOUSTON, TX (US); BEIJING HUAMEI INC., Beijing (CN)

(72) Inventors: Lulu Song, Houston, TX (US); David Schreckengost, Houston, TX (US)

(73) Assignees: CNPC USA CORPORATION, HOUSTON, TX (US); BEIJING HUAMEI INC., Beijing (CN)

(21) Appl. No.: 16/948,717

(22) Filed: Sep. 29, 2020

(51) Int. Cl. C09K 8/74; C09K 8/70; C09K 8/72

(52) U.S. Cl. CPC C09K 8/74; C09K 8/725; C09K 8/70

(57) ABSTRACT

Disclosed herein are breaking additives and methods for use with synthetic polymer-type fracturing fluids. Compared with polysaccharide-type gelling agents, such as guar and guar derivatives, synthetic-polymers such as polyacrylamide-type gelling agents are more difficult to break using common oxidizing breakers because their backbones are composed of strong carbon-carbon bonds.

### FIELD

The disclosure relates generally to the oil and gas industry. The disclosure relates specifically to polymer stimulation fluids.

### BACKGROUND

Slickwater fracturing fluids have been successfully applied in hydraulic fracturing of unconventional formations, especially shales at shallower depths. In slickwater fracturing, chemicals are added to water to increase fluid flow in hydraulic fracturing. With deeper wells, fracturing fluids with higher viscosity and better proppant-carrying properties can be obtained by crosslinking a friction reducer. The advantages of directly crosslinking a friction reducer to form a crosslinked fracturing fluid are several. Firstly, the logistics and field operation are simpler. There is no need for another gelling agent as currently most fracturing jobs for unconventional formations are hybrid fracturing. Secondly, by using a synthetic polymer instead of a biopolymer such as guar gum, there is much less concern about the premature degradation of the gelling agent when flowback/produced water is used to prepare fracturing fluids. Thirdly, the carbon-carbon backbones of friction reducer molecules provide better temperature stability. Furthermore, unlike guar-type fluids, when fully broken, there is no residue in the final fluid to cause formation damage.

However, with carbon-carbon backbones, synthetic polymers such as polyacrylamide-type friction reducers are difficult to break using common breakers such as persulfates, peroxides, chlorites, bromates, and other as well as the encapsulated versions of these breakers. Many times, even at significantly higher than normal dosages of these conventional breakers, after breaking steps, the synthetic polymer fracturing fluids are only partially or locally broken with large portions still being thick gels, causing significant damage to the proppant packs, fractures, and surfaces of formations.

### SUMMARY

An embodiment of the disclosure is a composition for breaking a synthetic-polymer stimulation fluid comprising: a breaking additive comprising transition metals immobilized on a porous substrate or a biopolymer. In an embodiment, the transition metals are selected from the group consisting of iron, copper, and manganese. In an embodiment, the porous substrate is selected from the group consisting of: a zeolite, an active carbon, a porous silica, and a clay. In an embodiment, the biopolymer is alginate or carrageenan. In an embodiment, the breaking additive comprises a zeolite-supported iron. In an embodiment, the breaking additive comprises an active-carbon-supported iron. In an embodiment, the breaking additive comprises an alginate-supported iron. In an embodiment, the breaking additive comprises a silica-supported iron. In an embodiment, the composition further comprises one or more oxidizing agents. In an embodiment, the one or more oxidizing agents are selected from the group consisting of: oxygen, hydrogen peroxide, ammonium persulfate, calcium peroxide, chlorites, and bromates.

An embodiment of the disclosure is a method of breaking a synthetic-polymer stimulation fluid comprising: preparing a breaking additive comprising transition metals selected from the group consisting of iron, copper, and manganese immobilized on a porous substrate or biopolymer; adding the breaking additive to a fracturing fluid to form a downhole fluid; pumping the downhole fluid downhole; and allowing advanced oxidative processes to occur resulting in the breaking of a backbone of a synthetic polymer present in the fracturing fluid. In an embodiment, the porous substrate is selected from the group consisting of: a zeolite, an active carbon, a porous silica, and a clay. In an embodiment, the biopolymer is alginate or carrageenan. In an embodiment, the concentration of the transition metal in the fracturing fluid is 1-1000 ppm. In an embodiment, one or more oxidizing agents selected from the group consisting of: oxygen, hydrogen peroxide, ammonium persulfate, sodium persulfate, potassium persulfate, magnesium peroxide, calcium peroxide, chlorites and bromates are added to the fracturing fluid. In an embodiment, the breaking additive is added in conjunction with one or more other breaking additives. In an embodiment, the breaking of the backbone occurs at a temperature of less than 280 degrees Celsius. In an embodiment, the breaking of the backbone occurs at a temperature of less than 180 degrees Celsius. In an embodiment, the breaking of the backbone occurs between a temperature of 20 degrees Celsius and 180 degrees Celsius. In an embodiment, the synthetic polymer is a polyacrylamide.

An embodiment of the disclosure is a composition for breaking a synthetic-polymer stimulation fluid comprising: a breaking additive comprised of transition metals immobilized on either a porous substrate or a biopolymer. In an embodiment, the transition metals are selected from the group consisting of iron, copper, and manganese. In an embodiment, the porous substrate is selected from the group consisting of: a zeolite, an active carbon, a porous silica, and a clay. In an embodiment, the biopolymer is alginate or carrageenan. In an embodiment, the breaking additive is a zeolite-supported iron. In an embodiment, the breaking additive is an active carbon-supported iron. In an embodiment, the breaking additive is an alginate-supported iron. In an embodiment, the loading of the breaking additives can be between 10 and 20 ppt (pounds per thousand gallon of fracturing fluids). In an embodiment the nominal iron loading is 15-35 ppm (parts per million) in a fracturing fluid. In a further embodiment, the breaking additive is a silica-supported iron. In an embodiment, the breaking additive is selected from the group consisting of zeolite-supported iron with the nominal concentration of iron in a fracturing fluid being 1-1000 ppm, active-carbon-supported iron with the nominal concentration of iron in a fracturing fluid being 1-1000 ppm, alginate-supported iron with the nominal concentration of iron in a fracturing fluid being 1-1000 ppm, and silica-supported iron with the nominal concentration of iron in a fracturing fluid being 1-1000 ppm. In an embodiment, the breaking additive is selected from the group consisting of zeolite-supported iron with the nominal concentration of iron in a fracturing fluid being 0.1-10000 ppm, active-carbon-supported iron with the nominal concentration of iron in a fracturing fluid being 0.1-10000 ppm, alginate-supported iron with the nominal concentration of iron in a fracturing fluid being 0.1-10000 ppm, and silica-supported iron with the nominal concentration of iron in a fracturing fluid being 0.1-10000 ppm. In an embodiment, the breaking additive is selected from the group consisting of zeolite-supported iron with the loading of the breaking additive being 10 ppt, active carbon-supported iron with the loading of the breaking additive being 10 ppt, alginate-supported iron with the loading of the breaking additive being 20 ppt, and silica-supported iron with the loading of the breaking additive being 20 ppt. In an embodiment, the composition further comprises one or more oxidizing agents. In an embodiment, the one or more oxidizing agents are selected from the group consisting of: oxygen, hydrogen peroxide, ammonium persulfate, sodium persulfate, potassium persulfate, magnesium peroxide, calcium peroxide, chlorites, and bromates.

An embodiment of the disclosure is a method of breaking a synthetic-polymer stimulation fluid comprising: preparing a breaking additive comprising transition metals selected from the group consisting of iron, copper, and manganese immobilized on a porous substrate or biopolymer; adding the breaking additive to a fracturing fluid to form a downhole fluid; pumping the downhole fluid downhole; and allowing advanced oxidative processes to occur resulting in the breaking of a backbone of a synthetic polymer present in the fracturing fluid. An embodiment of the disclosure is a method of breaking a synthetic-polymer stimulation fluid comprising: preparing a breaking additive comprising transition metals selected from the group consisting of iron, copper, and manganese immobilized on a porous substrate or biopolymer; adding the breaking additive to a fracturing fluid in conjunction with one or more oxidizing agents to form a downhole fluid; pumping the downhole fluid downhole; and allowing advanced oxidative processes to occur resulting in the breaking of a backbone of a synthetic polymer present in the fracturing fluid. In an embodiment, the one or more oxidizing agents is oxygen. In an embodiment, the oxygen is dissolved or trapped in the fracturing fluid. In an embodiment, the oxygen is from the air. In an embodiment, the porous substrate is selected from the group consisting of: a zeolite, an active carbon, a porous silica, and a clay. In an embodiment, the biopolymer is alginate or carrageenan. In an embodiment, the breaking additive is selected from the group consisting of zeolite-supported iron with the nominal concentration of iron in the fracturing fluid being 1-1000 ppm, active-carbon-supported iron with the nominal concentration of iron in the fracturing fluid being 1-1000 ppm, alginate-supported iron with the nominal concentration of iron in the fracturing fluid being 1-1000 ppm, and silica-supported iron with the nominal concentration of iron in the fracturing fluid being 1-1000 ppm. In an embodiment, the breaking additive is selected from the group consisting of zeolite-supported iron with the nominal concentration of iron in the fracturing fluid being 0.1-10000 ppm, active carbon-supported iron with the nominal concentration of iron in the fracturing fluid being 0.1-10000 ppm, alginate-supported iron with the nominal concentration of iron in the fracturing fluid being 0.1-10000 ppm, and silica-supported iron with the nominal concentration of iron in the fracturing fluid being 0.1-10000 ppm. In an embodiment, the breaking additive is selected from the group consisting of zeolite-supported iron with the loading of the breaking additive being 10 ppt, active carbon-supported iron with the loading of the breaking additive being 10 ppt, alginate-supported iron with the loading of the breaking additive being 20 ppt, and silica-supported iron with the loading of the breaking additive being 10 ppt. In an embodiment, the one or more oxidizing agents are selected from the group consisting of: oxygen, hydrogen peroxide, ammonium persulfate, calcium peroxide, chlorites and bromates. In an embodiment, the breaking additive is added in conjunction with one or more other breaking additives. In an embodiment, the breaking of the backbone occurs at a temperature of less than 180 degrees Celsius. In an embodiment, the breaking of the backbone occurs at a temperature of 180 degrees Celsius to 280 degrees Celsius. In an embodiment, high temperatures should not prevent the additives from working. In an embodiment, the breaking of the backbone occurs between a temperature of 20 degrees Celsius and 120 degrees Celsius. In an embodiment, the breaking of the backbone occurs between a temperature of 20 degrees Celsius and 120 degrees Celsius. In an embodiment, the synthetic polymer is a polyacrylamide.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE DRAWINGS

In order that the manner in which the above-recited and other enhancements and objects of the disclosure are obtained, a more particular description of the disclosure briefly described above will be rendered by reference to specific embodiments thereof which are illustrated in the appended drawings. Understanding that these drawings depict only typical embodiments of the disclosure and are therefore not to be considered limiting of its scope, the disclosure will be described with additional specificity and detail through the use of the accompanying drawings in which:

FIG. 1 is a graph of the apparent viscosity of the cross-linked polyacrylamide fracturing fluid after being aged at 120° C. for 16 hours without breaker, with a market product of encapsulated ammonium persulfate, or with a zeolite-supported iron respectively. The viscosity measurements were conducted at room temperature and a series of shear rates (10 s⁻¹, 25 s⁻¹, 50 s⁻¹, 75 s⁻¹, 100 s⁻¹, and 170 s⁻¹);

FIG. 2 is a graph of the apparent viscosity of the cross-linked polyacrylamide fracturing fluid after being aged at 120° C. for 39 hours without breaker, with a market product of encapsulated ammonium persulfate, or with the zeolite-supported iron respectively. The viscosity measurements were conducted at room temperature and at a series of shear rates (10 s⁻¹, 25 s⁻¹, 50 s⁻¹, 75 s⁻¹, 100 s⁻¹, and 170 s⁻¹);

FIG. 3 is a graph of the apparent viscosity of the cross-linked polyacrylamide fracturing fluid after being aged at 120° C. for 40 hours with the active-carbon-supported iron. The viscosity measurements were conducted at room temperature and at a series of shear rates (10 s⁻¹, 25 s⁻¹, 50 s⁻¹, 75 s⁻¹, 100 s⁻¹, and 170 s⁻¹);

FIG. 4 is a graph of the apparent viscosity of the cross-linked polyacrylamide fracturing fluid after being aged at 120° C. for 34 hours, without breaker (Viscosity_Blank 34 hrs) or with an alginate-supported iron (viscosity_20 ppt FeAlginate_34 hrs), respectively. The viscosity measurements were conducted at room temperature and at a series of shear rates (10 s⁻¹, 25 s⁻¹, 50 s⁻¹, 75 s⁻¹, 100 s⁻¹, and 170 s⁻¹);

FIG. 5 is a graph of the apparent viscosity of the cross-linked polyacrylamide fracturing fluid after being aged at 120° C. for 16 hours, without breaker (Viscosity_Blank_16 hrs) or with a porous-silica-supported iron (Viscosity_20 ppt FeSilica_16 hrs), respectively. The viscosity measurements were conducted at room temperature and at a of shear rates (10 s⁻¹, 25 s⁻¹, 50 s⁻¹, 75 s⁻¹, 100 s⁻¹, and 170 s⁻¹);

FIG. 6 is a graph of the apparent viscosity at 120° C. of the cross-linked polyacrylamide fracturing fluid over the initial 2 hours after being prepared, without any breaker (Blank), with encapsulated ammonium persulfate (with 7.5 ppt EnAPS), with active-carbon-supported iron (with 10 ppt Fe-ActiveCarbon or with 20 ppt Fe-ActiveCarbon), or with alginate-supported iron (with 10 ppt Fe-Alginate).

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

Conventional breakers cannot effectively break fracturing fluids thickened or gelled with synthetic polymers such as polyacrylamides at temperatures below 180° C. The disclosed breaking additives can be used alone or together with conventional oxidizing breakers to effectively break synthetic polymer type fracturing fluids without affecting the rheological performance of the fracturing fluids at earlier stages. Heterogeneous advanced oxidation processes are utilized to break synthetic polymer type fracturing fluids with immobilized transition metal species. The disclosed breaking additives will be pumped downhole in fracturing fluids alone or together with conventional oxidizing breakers. Some oxidizing breakers including, but not limited to, calcium peroxide and encapsulated ammonium persulfate are not water soluble, which is utilized to get delayed breaking performance.

The disclosed breaking additives are comprised of species of transition metals with two potential oxidation states including but not limited to iron, copper, ruthenium, silver, cobalt, palladium, titanium, nickel, gold, platinum, or manganese immobilized on porous substrates with surface charges or transition metal anchoring functional groups including but not limited to zeolite, active carbon, porous silica, clay, nafion, resin, layered materials, carbon xerogel, carbon nanotubes, acid-activated fly ash, graphene oxide, mesoporous carbon, carbon aerogel, alumina, hydrotalcite-like compounds, or on biopolymers including but not limited to alginate or carrageenan chitosan, bacterial cellulose, carboxymethyl cellulose, starch, guar gum, or xanthan gum. Natural and synthesized minerals containing transition metals such as pyrite, hematite, goethite, etc. and zero-valent state metals, such as Fe⁰ and Zn⁰, can also be used as breaking additives. In an embodiment, any transition metal which has at least 2 potential oxidation states can work as a catalyst. In an embodiment, any solid with surface charges or/and functional groups which can anchor the transition metal ions can be used. In an embodiment, one or more of any of these substances can be present. In an embodiment, one or more of each of these substances can be present. When transition metal species are added into aqueous solutions in the presence of oxidizers including but not limited to oxygen, hydrogen peroxide, ammonium persulfate, calcium peroxide, chlorites and/or bromates, advanced oxidation processes (AOPs) take place. During AOPs, powerful oxidative species, such as hydroxyl radicals and sulfate radicals, are generated, which effectively break down the backbones of the synthetic polymeric gelling agents of fracturing fluids. Instead of directly adding transition metal species into the aqueous fracturing fluids (generally referred as homogeneous processes), AOPs with transition metal species immobilized on a supporting material such as porous substrates and biopolymers (generally referred as heterogeneous processes) provide delayed but effective break for the fracturing fluids.

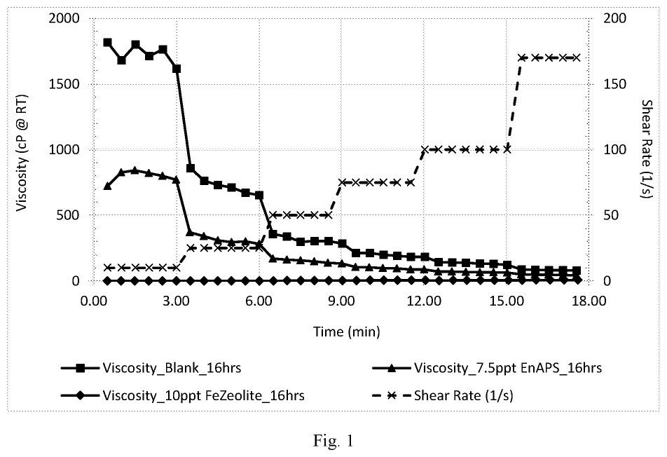

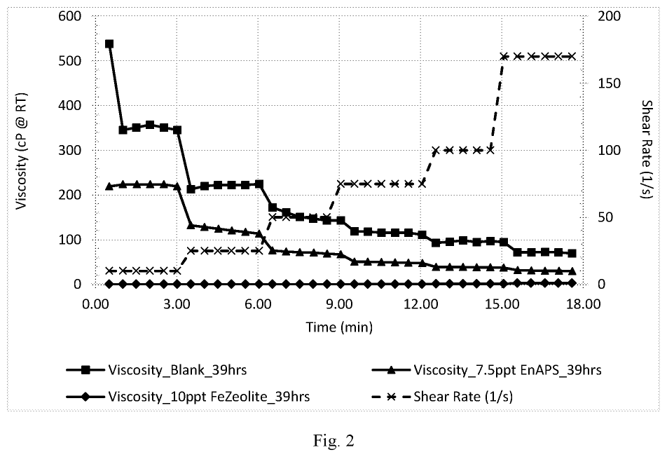

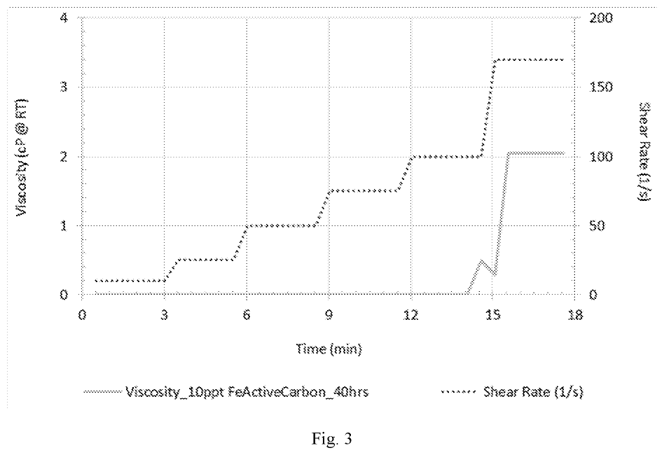

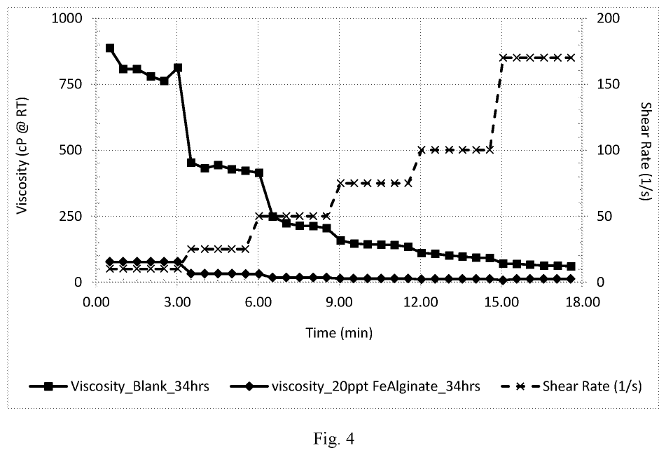

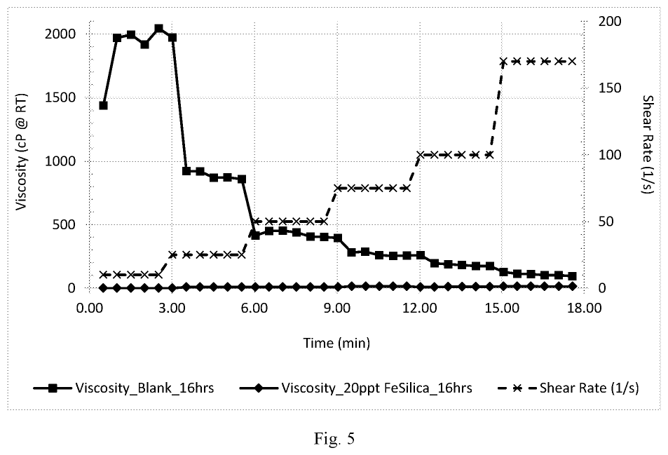

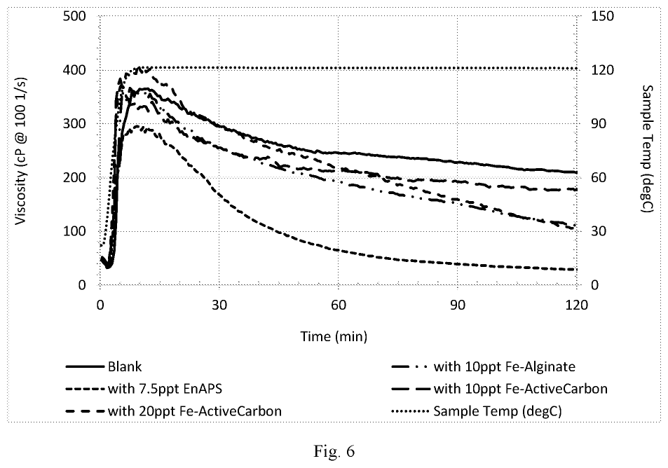

The disclosed breaking additives were used to break a cross-linked polyacrylamide fracturing fluid at 120° C. but could be used at a broad range of temperatures from room temperature up to higher temperatures with adjustment of the concentration of the loading catalysts and oxidizers. In an embodiment, room temperature is 20° C. In an embodiment, lower temperatures would require higher loading of the catalysts and oxidizers. FIG. 1-FIG. 5 show that the final viscosity of the aged fracturing fluid samples with the disclosed breaking additives was much lower than the sample without breaker and the sample with a conventional breaker (encapsulated ammonium persulfate). Also, the disclosed breaking additives affected the initial high temperature (HT) viscosity of the fracturing fluid to a much less extent compared to the conventional encapsulated ammonium persulfate breaker (FIG. 6).

In an embodiment, the loading of the iron is measured in ppm (parts per million) of the transition metal only (not including supporting substrates or biopolymers). In an embodiment, the nominal concentration of the transition metal in the fracturing fluid is defined as the mass of the transition metal only (not counting the supporting substrates or biopolymers) per the mass of the fracturing fluid. This does not count the masses of the supporting materials such as zeolite, active carbon, etc. The ppm loadings are for the iron/transition metals only and do not include the supporting materials (the mass of the iron per volume of the fracturing fluid).

In an embodiment, the loading of the breaking additives are measured in ppt (pounds per thousand gallon of fracturing fluids). The ppt loadings in the examples and figures are the loadings of the breaking additives (the mass of the iron and the supporting materials per volume of the fracturing fluid). As an example, for 10 ppt of zeolite-supported iron breaking additive, the iron loading is about 30 ppm.

An embodiment of the disclosure is a composition for breaking a synthetic-polymer stimulation fluid comprising a breaking additive comprised of transition metals immobilized on either a porous substrate or a biopolymer. In an embodiment, the transition metals are selected from the group consisting of iron, copper, and manganese. In an embodiment, the porous substrate is selected from the group consisting of a zeolite, an active carbon, a porous silica, and a clay. In an embodiment, the biopolymer is alginate or carrageenan. In an embodiment, the breaking additive is a zeolite-supported iron. In an embodiment, the breaking additive is an active carbon-supported iron. In an embodiment, the breaking additive is an alginate-supported iron. In an embodiment, the loading of the breaking additives can be between 10 and 20 ppt. In an embodiment, the iron loading is 15-60 ppm. In a further embodiment, the breaking additive is a silica-supported iron. In an embodiment, the breaking additive is selected from the group consisting of 10 ppt zeolite-supported iron, 10 ppt active carbon-supported iron, 20 ppt alginate-supported iron, and 20 ppt silica-supported iron. In an embodiment, active ingredient concentration, including but not limited to the concentration of iron or other transition metals, is 1-1000 ppm (parts per million). In an embodiment, the breaking additive is selected from the group consisting of 1-1000 ppm zeolite-supported iron, 1-1000 ppm active carbon-supported iron, 1-1000 ppm alginate-supported iron, and 1-1000 ppm silica-supported iron. In an embodiment, the breaking additive is selected from the group consisting of 0.1-10000 ppm zeolite-supported iron, 0.1-10000 ppm active carbon-supported iron, 0.1-10000 ppm alginate-supported iron, and 0.1-10000 ppm silica-supported iron.

In an embodiment, the breaking additives are substrate-supported iron. In an embodiment, iron is the active component which catalyzes the oxidation. In an embodiment, the loadings of the Fe²⁺ were estimated using ICP. The estimated Fe²⁺ loadings were 15-60 ppm. In an embodiment, adding more of the breaking additives will speed up the breaking process.

In an embodiment, a breaking additive can be directly added into a fracturing fluid alone. In an embodiment, the oxygen from the air trapped in the fracturing fluid functions as the oxidizer in the AOP process.

In an embodiment, the breaking additive and another oxidizing agent (e.g., hydrogen peroxide or an encapsulated ammonium persulfate) can be added into the fracturing fluid, respectively, at the same time or in sequence. In an embodiment, there is no need to pre-mix the breaking additive and the oxidizing agent before adding them into the fracturing fluid.

In an embodiment, the composition further comprises an aqueous solution comprising one or more oxidizing agents. In an embodiment, the one or more oxidizing agents are selected from the group consisting of oxygen, hydrogen peroxide, ammonium persulfate, calcium peroxide, chlorites, and bromates.

In an embodiment, oxygen in air dissolved and trapped in the fracturing fluid serves as the oxidizing agent.

An embodiment of the disclosure is a method of breaking a synthetic-polymer stimulation fluid comprising: preparing a breaking additive comprising transition metals selected from the group consisting of iron, copper, and manganese immobilized on a porous substrate or biopolymer; adding the breaking additive alone or together with one or more oxidizing agents to form a fracturing fluid additive; adding the fracturing fluid additive to a fracturing fluid to form a downhole fluid; pumping the downhole fluid downhole; and allowing advanced oxidative processes to occur resulting in the breaking of a backbone of a synthetic polymer present in the fracturing fluid. In an embodiment, the porous substrate is selected from the group consisting of a zeolite, an active carbon, a porous silica, and a clay. In an embodiment, the biopolymer is alginate or carrageenan. In an embodiment, the breaking additive is selected from the group consisting of 10 ppt zeolite-supported iron, 10 ppt active carbon-supported iron, 20 ppt alginate-supported iron, and 20 ppt silica-supported iron. In an embodiment, the concentration of iron or other transition metals is 1-1000 ppm (parts per million). In an embodiment, the loading is not fixed for each breaking additive. In an embodiment, active ingredient concentration, including but not limited to the concentration of iron or other transition metals, is 1-1000 ppm (parts per million). In an embodiment, the breaking additive is selected from the group consisting of 1-1000 ppm zeolite-supported iron, 1-1000 ppm active carbon-supported iron, 1-1000 ppm alginate-supported iron, and 1-1000 ppm silica-supported iron. In an embodiment, the breaking additive is selected from the group consisting of 0.1-10000 ppm zeolite-supported iron, 0.1-10000 ppm active carbon-supported iron, 0.1-10000 ppm alginate-supported iron, and 0.1-10000 ppm silica-supported iron.

In an embodiment, the one or more oxidizing agents are selected from the group consisting of oxygen, hydrogen peroxide, ammonium persulfate, calcium peroxide, chlorites and bromates. In an embodiment, the breaking additive is added in conjunction with one or more other breaking additives. In an embodiment, the breaking can happen from room temperature up to higher temperatures. In an embodiment, lower temperatures will need higher loading of the catalysts and oxidizers. In an embodiment, the breaking of the backbone occurs at a temperature of less than 180 degrees Celsius. In an embodiment, the breaking of the backbone occurs at a temperature of about 20 degrees Celsius to 180 degrees Celsius. In an embodiment, the breaking of the backbone occurs at a temperature of 120 degrees Celsius. In an embodiment, the breaking of the backbone occurs at a temperature of about 20 degrees Celsius to 120 degrees Celsius. In an embodiment, the synthetic polymer is a cross-linked polyacrylamide. In an embodiment, the synthetic polymer is a polyacrylamide.

In an embodiment, immobilized catalysts can be utilized to break synthetic fracturing fluids. In an embodiment, a wide variety of preparation methods with different loadings of reagents exist. In an embodiment, more than one transition metal could be used together in catalyzing an oxidation process.

### EXAMPLES

### Example 1

The zeolite-supported iron was prepared as follows. 8 g of dried sodium Y zeolite powder (from Sigma-Aldrich) was soaked in 40 mL of a 0.176M DI water solution of FeSO₄.7H₂O and stirred constantly with a magnetic stirrer at room temperature for about 15-20 hours. The slurry was then filtered through a 2.7-micron filter paper under vacuum and the collected solid particles were further rinsed with 500 mL DI water. The washed solids were then put into a vacuum oven to dry overnight to obtain the zeolite-supported iron.

### Example 2

The active-carbon-supported iron was prepared as follows. 8 g of dried active charcoal powder (DARCO®) was soaked in 40 mL of a 0.176M solution of FeSO₄.7H₂O in DI water and stirred constantly with a magnetic stirrer at room temperature for about 15-20 hours. The slurry was then filtered through a 2.7-micron filter paper under vacuum and the collected solid particles were further rinsed with 500 mL DI water. The washed solids were then put into a vacuum oven to dry overnight to obtain the active-carbon-supported iron.

### Example 3

The alginate-supported iron was prepared as follows. About 0.6 g of sodium alginate (from Sigma Aldrich) was added into 200 mL of DI water and stirred for 2.5 hours to get the alginate fully hydrated. After the pH of the alginate solution was adjusted to around 5 using 10% HCl, about 1 g of Span-80 (from Sigma Aldrich) was added and stirred for 2 h at 60° C. Meanwhile, 0.015 g of FeSO₄.7H₂O and 0.001 g of ascorbic acid were added into 100 mL of DI water and stirred for 30 min. Then, 80 mL of the sodium alginate/Span-80 mixture was stirred with 50 mL of the ferrous sulphate/ascorbic acid solution for about 2 hours. After that, 80 mL of CaCl₂ aqueous solution (0.1% w/v) was added drop-wise into the above mixture while being stirred at 1200 rpm for 1 h. The final mixture was then centrifuged at 4300 rpm for 1 hour and the precipitate was dried in vacuum oven overnight to obtain the alginate-supported iron.

### Example 4

The porous-silica-supported iron was prepared as follows. 8 g of silica gel (technical grade 40 from Sigma Aldrich) was soaked in 40 mL of a 0.176M solution of FeSO₄.7H₂O in DI water and stirred constantly with a magnetic stirrer at room temperature for about 15-20 hours. Then the slurry was filtered through a 2.7-micron filter paper under vacuum and the collected solid particles were further rinsed with 500 mL DI water. The washed solids were then put into a vacuum oven to dry overnight to obtain the porous-silica-supported iron.

All such similar substitutes and modifications apparent to those skilled in the art are deemed to be within the spirit, scope and concept of the disclosure as defined by the appended claims.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain agents which are both chemically related may be substituted for the agents described herein while the same or similar results would be achieved. All such similar substitutes and modifications apparent to those skilled in the art are deemed to be within the spirit, scope and concept of the disclosure as defined by the appended claims.

What is claimed is:

1. A composition for breaking a synthetic-polymer stimulation fluid comprising:
a breaking additive comprising transition metals immobilized on a porous substrate or a biopolymer.

2. The composition of claim 1 wherein the transition metals are selected from the group consisting of iron, copper, and manganese.

3. The composition of claim 1 wherein the porous substrate is selected from the group consisting of: a zeolite, an active carbon, a porous silica, and a clay.

4. The composition of claim 1 wherein the biopolymer is alginate or carrageenan.

5. The composition of claim 1 wherein the breaking additive comprises a zeolite-supported iron.

6. The composition of claim 1 wherein the breaking additive comprises an active carbon-supported iron.

7. The composition of claim 1 wherein the breaking additive comprises an alginate-supported iron.

8. The composition of claim 1 wherein the breaking additive comprises a silica-supported iron.

9. The composition of claim 1, further comprising one or more oxidizing agents.

10. The composition of claim 9 wherein the one or more oxidizing agents are selected from the group consisting of: oxygen, hydrogen peroxide, ammonium persulfate, calcium peroxide, chlorites, and bromates.

11. A method of breaking a synthetic-polymer stimulation fluid comprising:
preparing a breaking additive comprising transition metals selected from the group consisting of iron, copper, and manganese immobilized on a porous substrate or biopolymer;
adding the breaking additive to a fracturing fluid to form a downhole fluid;
pumping the downhole fluid downhole; and
allowing advanced oxidative processes to occur resulting in the breaking of a backbone of a synthetic polymer present in the fracturing fluid.

12. The method of claim 11 wherein the porous substrate is selected from the group consisting of: a zeolite, an active carbon, a porous silica, and a clay.

13. The method of claim 11 wherein the biopolymer is alginate or carrageenan.

14. The method of claim 11 wherein the concentration of the transition metal in the fracturing fluid is 1-1000 ppm.

15. The method of claim 11 wherein one or more oxidizing agents selected from the group consisting of: oxygen, hydrogen peroxide, ammonium persulfate, sodium persulfate, potassium persulfate, magnesium peroxide, calcium peroxide, chlorites and bromates are added to the fracturing fluid.

16. The method of claim 11 wherein the breaking additive is added in conjunction with one or more other breaking additives.

17. The method of claim 11 wherein the breaking of the backbone occurs at a temperature of less than 280 degrees Celsius.

18. The method of claim 11 wherein the breaking of the backbone occurs at a temperature of less than 180 degrees Celsius.

19. The method of claim 18 wherein the breaking of the backbone occurs between a temperature of 20 degrees Celsius and 180 degrees Celsius.

20. The method of claim 11 wherein the synthetic polymer is a polyacrylamide
